(19) United States
(12) Patent Application Publication
(10) Pub. No.: US 2017/0185742 A1
(43) Pub. Date: Jun. 29, 2017

(54) DRUG DELIVERY SYSTEM WITH DELIVERY BASED ON PATIENT DATA

(71) Applicant: Ethicon Endo-Surgery, Inc., Cincinnati, OH (US)

(72) Inventors: Paul J. Niklewski, Cincinnati, OH (US); James F. Martin, Lebanon, OH (US); James R. Jackson, Cincinnati, OH (US)

(21) Appl. No.: 14/982,152

(22) Filed: Dec. 29, 2015

(51) Int. Cl. G06F 19/00

(52) U.S. Cl. CPC G06F 19/3456; G06F 19/3431

(57) ABSTRACT

Patient demographics gathered from a variety of sources are used to create one or more cumulative risk factors that is used to configure a set of initial drug delivery rules controlling factors such as dosing limits, lockouts, alarm thresholds, and informational displays. These initial drug delivery rules may then be modified during a procedure according to a pharmacodynamic profile that is created, updated, and maintained in real time based upon one or more sources of feedback, such as sensors providing information on patient responsiveness, patient cardiovascular conditions, patient pain levels, and clinician inputs. As the system proposes new or modified drug delivery conditions based upon demographic information and real time feedback, clinicians may review and accept or refuse the proposed changes.

### BACKGROUND

Patient monitoring systems may be used to monitor physiological parameters of patients undergoing diagnostic procedures, surgical procedures, and/or various other types of medical procedures. In various settings, it may also be desirable to deliver drugs to a patient during a procedure, such as via an IV and/or face mask, etc. Such drugs may include sedatives, anelgesics, amnestics, etc. In some instances, such drugs may be selected and/or combined to place a patient in a state of “conscious sedation” (in lieu of simply rendering a patient completely unconscious through a general anesthetic). Certain systems may also be used to automate the delivery of such drugs. For instance, such systems may be located in the same room where a medical procedure is performed, and may be coupled with a physiological monitoring system to automatically tailor the delivery of drugs based on patient parameters detected by the monitoring system.

Examples of such systems are disclosed in U.S. Pat. No. 6,745,764, entitled “Apparatus and Method for Providing a Conscious Patient Relief from Pain and Anxiety Associated with Medical or Surgical Procedures,” issued Jun. 8, 2004, the disclosure of which is incorporated by reference herein; U.S. Pat. No. 7,833,213, entitled “Patient Monitoring and Drug Delivery System and Method,” issued Nov. 16, 2010, the disclosure of which is incorporated by reference herein; U.S. Pat. No. 7,935,081, entitled “Drug Delivery Cassette and a Medical Effector System,” issued May 3, 2011, the disclosure of which is incorporated by reference herein; U.S. Pub. No. 2009/0292179, entitled “Medical System having a Medical Unit and a Display Monitor,” published Nov. 26, 2009, the disclosure of which is incorporated by reference herein; and U.S. Pub. No. 2010/0010433, entitled “Medical System which Controls Delivery of a Drug,” published Jan. 14, 2010, the disclosure of which is incorporated by reference herein.

One difficulty in current drug delivery settings is that patients may exhibit a wide variety of pharmacodynamic (“PD”) responses to drugs based upon numerous factors. Two apparently similar patients may react very differently to identical doses if certain factors are not properly considered for each unique patient, both in isolation and in combination with others factors. Such factors may include conditions measured in real-time, such as a patient's present heart rate and cardiac ejection fraction, as well as conditions that may be recorded as part of a patient's demographic data, such as a patient's height or weight, a past reaction to a particular drug, or other factors such as prior procedures and current medications. This demographic data can greatly influence the outcome of drug delivery and sedation techniques, as pre-existing conditions, medications, and other factors may increase or decrease a patient's sensitivity to a delivered drug. Additionally, the stimulus a patient receives may impact their PD response, as well as their tolerance to nociceptive stimuli.

While a variety of systems have been made and used for monitoring patients and delivering drugs to patients, it is believed that no one prior to the inventor(s) has made or used the technology as described herein.

### BRIEF DESCRIPTION OF THE DRAWINGS

It is believed the present invention will be better understood from the following description of certain examples taken in conjunction with the accompanying drawings, in which like reference numerals identify the same elements and in which:

FIG. 1 depicts a perspective view of an exemplary patient monitoring and drug delivery system;

FIG. 2 depicts a perspective view of the patient monitoring unit of the system of FIG. 1;

FIG. 3 depicts a perspective view of the drug delivery unit of the system of FIG. 1;

FIG. 4 depicts a block diagrammatic view of the system of FIG. 1 with additional exemplary components;

FIG. 5 depicts a flowchart showing an exemplary method that may be performed using the system of FIG. 1 to manage drug delivery based upon patient data;

FIG. 6 depicts a flowchart showing an exemplary method of processing demographic information;

FIG. 7 depicts a flowchart showing an exemplary method that may be performed using the system of FIG. 1 to process a demographic risk factor;

FIG. 8 depicts a schematic view of an exemplary queue for receiving and organizing real time data;

FIG. 9 depicts a flowchart showing an exemplary method that may be performed using the system of FIG. 1 to create and maintain a pharmacodynamic profile; and

FIG. 10 depicts a flowchart showing an exemplary method that may be performed using the system of FIG. 1 to apply a pharmacodynamic profile to an ongoing procedure.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

### I. Overview

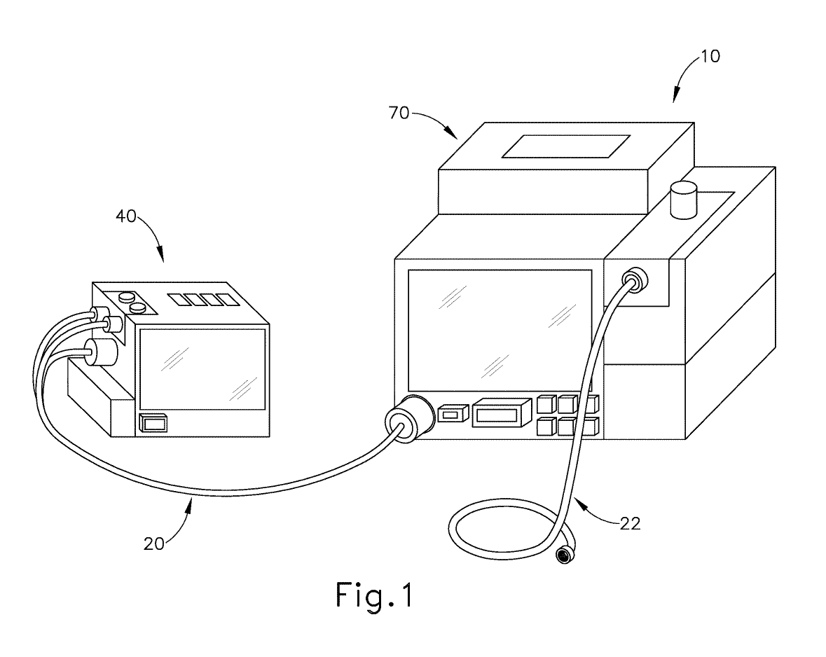

FIG. 1 shows an exemplary patient care system (10) comprising a bedside monitor unit (BMU) (40) and a procedure room unit (PRU) (70). One exemplary use of patient care system (10) is to monitor patient parameters and deliver sedative, analgesic, and/or amnestic drugs to a conscious, non-intubated, spontaneously-ventilating patient undergoing a diagnostic procedure, surgical procedure, or other medical procedure by a physician. This use is not exhaustive of all of the potential uses of the invention but will be used to describe examples herein. BMU (40) and PRU (70) are connected via communication cable (20). Communication cable (20) provides means for transmitting electronic data as well as various hydraulic signals and gases between BMU (40) and PRU (70). For instance, communication cable (20) may include a plurality of pneumatic tubes and a plurality of electrical wires, all integrated within a single sheath or cable. Communication cable (20) may be removed from both BMU (40) and PRU (70) to facilitate practice efficiency and user convenience. BMU (40) and PRU (70) are free to move independently of each other if communication cable (20) is not in place. This allows for mobility of each unit independent of the other; this feature is especially important in hospitals that have a great deal of medical procedures and there is little time to connect patients to monitors. BMU (40) and PRU (70) preferably accommodate an external oxygen source that is intended to provide supplemental oxygen to the patient during the course of a surgical procedure if the clinician so desires. An IV tube set (22) is shown connected to PRU (70) and delivers sedative or amnestic drugs to a patient during a surgical procedure.

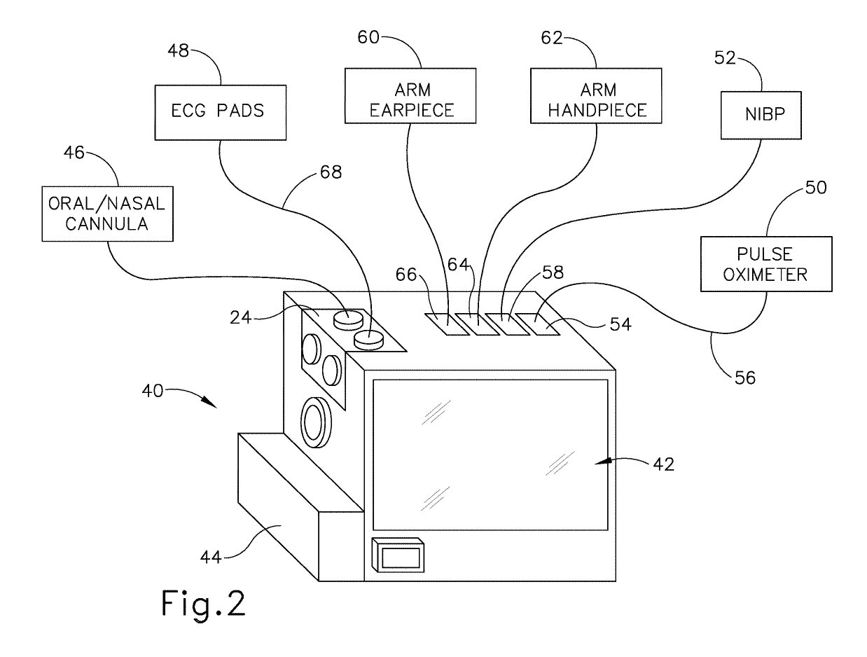

BMU (40) serves as a patient monitoring unit, monitoring various physiological parameters of a patient. As shown in FIG. 2, BMU (40) is compact and portable so it requires relatively little effort to move from one room to another. In some versions, BMU (40) could mount upon either an IV pole or a bedrail; this would free the clinician from the burden of carrying the unit wherever the patient needs to be transported. BMU (40) is small and light enough to be held in the hand of a nurse or technician. BMU (40) allows the user to input information via a touch screen assembly (42) or a simple keypad, etc. Touch screen assembly (42) is provided as an overlay on a display device that is integrated into one surface of BMU (40), and that displays patient and system parameters, and operational status of BMU (40). An exemplary bedside touch screen assembly (42) is a 5.25″ resistive touch screen manufactured by MicroTech mounted upon a 5.25″ color LCD screen manufactured by Samsung. Other suitable forms that a display screen and touch screen may take will be apparent to those of ordinary skill in the art in view of the teachings herein. An attending nurse or physician may enter patient information such as, for example, patient weight and a drug dose profile into BMU (40) by means of bedside touch screen assembly (42). A BMU battery (44) is fixedly attached to the BMU (40) and comprises a standard rechargeable battery such as, for example, Panasonic model no. LC-T122PU, that is capable of supplying sufficient power to run BMU (40) for an extended period of time. In some versions, BMU battery (44) can be recharged while BMU (40) is connected to PRU (70) via communication cable (20) or can be charged directly from an independent power source. Various suitable ways in which battery (44) may be charged will be apparent to those of ordinary skill in the art in view of the teachings herein. Similarly, various suitable forms that battery (44) may take, as well as various suitable compositions thereof, will be apparent to those of ordinary skill in the art in view of the teachings herein.

As shown in FIG. 2, BMU (40) may be connected to a plurality of patient sensors and peripherals used to monitor patient vital signs and deliver supplemental oxygen to the patient. Oral nasal cannula (46) delivers oxygen from an external oxygen source and collects samples of exhaled gas. Oral nasal cannula (46) is removably attached to cable pass-through connection (24). Cable pass-through connection (24) sends the signal obtained by oral nasal cannula (46) directly to a capnometer (e.g., a CardioPulmonary Technologies CO2WFA OEM) in PRU (70) and preferably via communication cable (20) (FIG. 1). The capnometer measures the carbon dioxide levels in a patient's inhalation/exhalation stream via a carbon dioxide-sensor as well as measuring respiration rate. Also attached to the cable pass-through connection (24) is a standard electrocardiogram (ECG) (48), which monitors the electrical activity in a patient's cardiac cycle. The ECG signals are sent to PRU (70) where the signals are processed. A pulse oximeter probe (50) (e.g., by Dolphin Medical) and a non-invasive blood pressure (NIBP) cuff (52) are also connected to BMU (40) in the present example. Pulse oximeter probe (50) measures a patient's arterial saturation and heart rate via an infrared diffusion sensor. The data retrieved by pulse oximeter probe (50) is relayed to pulse oximeter module (54) (e.g., by Dolphin Medical) by means of pulse oximeter cable (56). The NIBP cuff (52) (e.g., a SunTech Medical Instruments PN 92-0011-00) measures a patient's systolic, diastolic, and mean arterial blood pressure by means of an inflatable cuff and air pump (e.g., by SunTech Medical), also incorporated as needed. NIBP cuff (52) is removably attached to NIBP module (58) located on BMU (40).

In the present example, a patient's level of consciousness is detected by means of an Automated Responsiveness Monitor System (ARM), though like various other components described herein, an ARM system is merely optional and is not required. An exemplary ARM system is disclosed in U.S. Pub. No. 2005/0070823, entitled “Response Testing for Conscious Sedation Involving Hand Grip Dynamics,” published Mar. 31, 2005, the disclosure of which is incorporated by reference herein. The ARM system of the present example comprises a query initiate device and a query response device. The ARM system operates by obtaining the patient's attention with the query initiate device and commanding the patient to activate the query response device. The query initiate device may comprise any type of stimulus device such as a speaker via an earpiece (60), which provides an auditory command to a patient to activate the query response device. The query response device of the present example comprises is a handpiece (62) that can take the form of, for example, a toggle or rocker switch or a depressible button or other moveable member hand held or otherwise accessible to the patient so that the member can be moved or depressed by the patient upon the patient's receiving of the auditory signal or other instruction to respond. Alternatively, a vibrating mechanism may be incorporated into handpiece (62) that cues the patient to activate the query response device. For instance, in some versions, the query initiate device comprises a cylindrical handheld device (62), containing a small 12V DC bi-directional motor enabling the handheld device to vibrate the patient's hand to solicit a response.

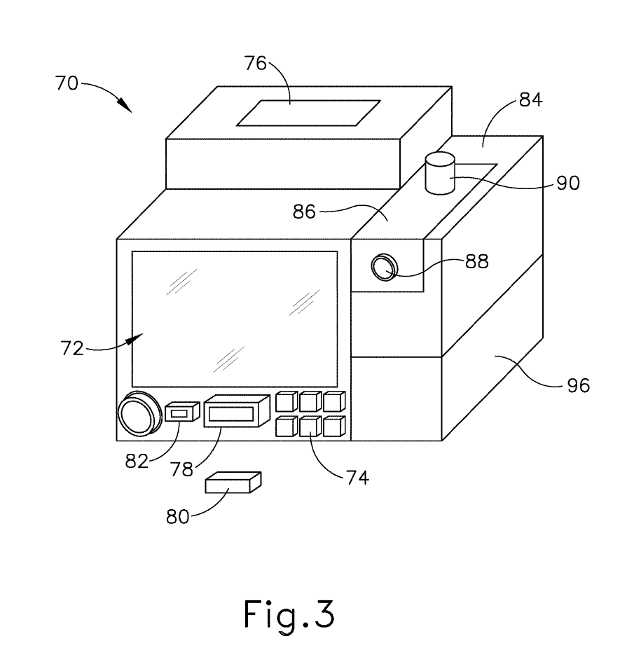

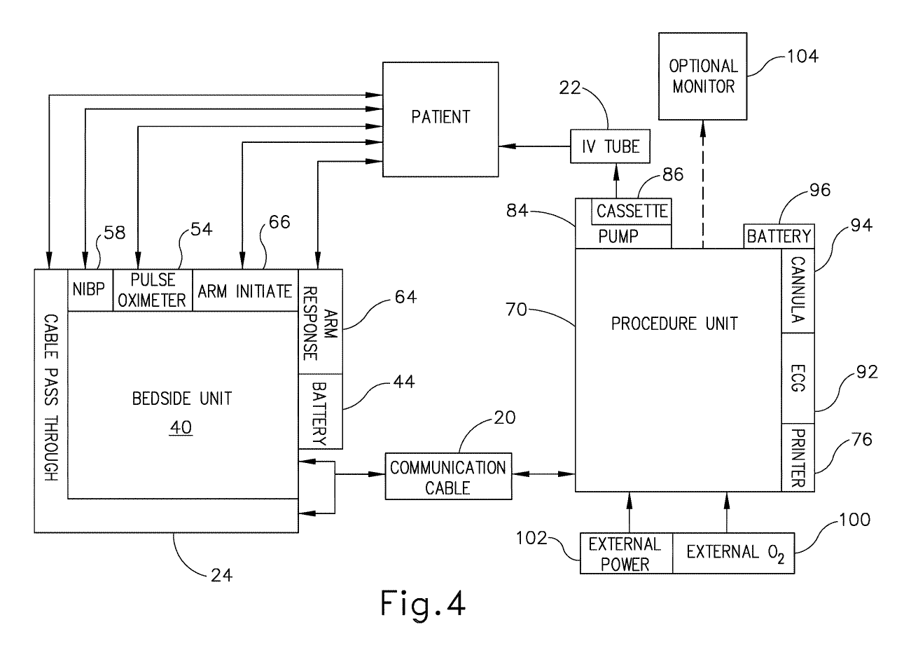

After the query is initiated, the ARM system generates signals to reflect the amount of time it took for the patient to activate the query response device in response to the query initiate device. These signals are processed by a logic board located inside BMU (40) and are displayed upon either bedside touch screen assembly (42), procedure touch screen assembly (72) (FIG. 3), and/or an optional monitor 104 (FIG. 4). The amount of time needed for the patient to respond to the query gives the clinician an idea as to the sedation level of the patient. The ARM system has two modules in this example, including a query response module (64) and a query initiate module (66), collectively referred to as the ARM system modules (64, 66). ARM system modules (64, 66) have all the necessary hardware to operate and connect the query response device (62) and the query initiate device (60) to BMU (40).

In some versions monitoring modules (54, 58, 64, 66) are easily replaceable with other monitoring modules in the event of malfunction or technological advancement. These modules (54, 58, 64, 66) include all of the necessary hardware to operate their respective peripherals. The above-mentioned patient modules (54, 58, 64, 66) are connected to a microprocessor-based electronic controller or computer (MLB) located within each of PRU (70) and BMU (40). The electronic controller or main logic board comprises a combination of available programmable-type microprocessors and other “chips,” memory devices and logic devices on various board(s) such as, for example, those manufactured by Texas Instruments (e.g., XK21E) and National Semiconductor (e.g., HKL72), among others. Various other suitable forms that modules (54, 58, 64, 66) and associated electronics may take will be apparent to those of ordinary skill in the art in view of the teachings herein.

Once BMU (40) and PRU (70) are connected via communication cable (20), ECG and capnography may be monitored, and supplemental oxygen may be delivered to the patient. It should be understood, however, that these connections may be made in the pre-procedure room to increase practice efficiency. By making these connections in the pre-procedure room, less time may be required in the procedure room connecting capnography, ECG and supplemental oxygen to PRU (70). Oral nasal cannula (46) and ECG leads (68) are connected directly to cable pass-through connection (24). Cable pass-through connection (24), located on BMU (40), is essentially an extension of communication cable (20), which allows the signals from ECG leads (68) and oral nasal cannula (46) to bypass BMU (40) and be transferred directly to PRU (70). It will be evident to those skilled in the art, however, that the BMU (40) could be configured to accept the ECG (48) and oral/nasal cannula (46) signals and process the signals accordingly to provide the information on screen (42) and supplemental oxygen to the patient in the pre-procedure room. Other examples of components, features, and functionality that may be incorporated into BMU (40) will be described in greater detail below; while still further examples of components, features, and functionality that may be incorporated into BMU (40) will be apparent to those of ordinary skill in the art in view of the teachings herein.

Referring now to FIG. 3, PRU (70) allows a physician to safely deliver drugs, such as sedative, analgesic, and/or amnestic drugs to a patient, and monitor the patient during a medical procedure. Procedure touch screen assembly (72) comprises a display device that is integrated into the surface of PRU (70), which displays patient and system parameters, and operation status of PRU (70). In some versions, procedure touch screen assembly (72) comprises a 15″ resistive touch screen manufactured by MicroTech mounted upon a 15″ color LCD screen manufactured by Samsung. Other suitable forms that a display screen and touch screen may take will be apparent to those of ordinary skill in the art in view of the teachings herein. It should be noted that, in the present example, procedure touch screen assembly (72) is the primary display and user input means, and is significantly larger than the bedside touch screen assembly (42) and is capable of displaying more detailed information. In addition to procedure touch screen assembly (72), the user may input information into PRU (70) by means of drug delivery controls (74). Drug delivery controls (74), such as buttons, dials, etc., are located on one side of PRU (70) and allow the clinician to change various system parameters and bypass procedure touch screen assembly (72). A printer (76) is integrally attached to the top of PRU (70). Printer (76) allows the clinician to print a patient report that includes patient data for pre-op and the procedure itself. The combination of printing a patient report and the automatic data logging features may decrease the amount of time and effort a nurse or technician must spend regarding patient condition during the course of a procedure. Printer (76) receives data signals from a printer interface (e.g., Parallel Systems CK205HS), which is located on the main logic board. Printer (76) may comprise a thermal printer (e.g., Advanced Printing Systems (APS) ELM 205HS) and/or any other suitable type of printer. It should also be understood that printer (76) may be remote from PRU (70) and may even be omitted altogether, if desired.

Memory card reader (78), which includes a slot in the outer casing of PRU (70), allows flash memory card (80) to be inserted and removed from PRU (70). Flash memory card (80) is a solid-state storage device used for easy and fast information storage of the data log generated by PRU (70). The data is stored so that it may be retrieved from flash memory card (80) at a later time. In some versions, memory card reader (78) accepts flash memory card (80) containing software to upgrade the functionality of patient care system (10). Again, as with other components described herein, memory card reader (78) may be modified, substituted, supplemented, or omitted as desired. In the present example, memory card reader (78) is supplemented with a data port (82). Data port (82) may include, but is not limited to, a standard serial port, a USB port, a RS232 port, an Ethernet port, or a wireless adapter (e.g., using IEEE 802.11n/g/b/a standard, etc.). Data port (82) may be used to link PRU (70) to an external printer to print a patient report or to transfer electronic files to a personal computer or mainframe. Examples of how data port (82) may be used to communicate with a centralized network system component will be apparent to those of ordinary skill in the art in view of the teachings herein.

PRU (70) delivers fluid to a patient via an infusion pump, such as a peristaltic infusion pump (84) (e.g., by B-Braun McGaw). Peristaltic infusion pump (84) is integrally attached to PRU (70), and uses peristaltic fingers to create a wavelike motion to induce fluid flow inside a flexible tube connected to a fluid reservoir. A drug cassette (86) is a generally rectangular shaped structure that is placed adjacent to peristaltic infusion pump (84). Drug cassette (86) of this example is made of a rigid thermoplastic such as, for example, polycarbonate. Drug cassette (86) has an internal cavity that houses IV tubing (22) made of a flexible thermoplastic such as, for example, polypropylene (e.g., Kelcourt). Drug cassette (86) receives tubing (22) via a port (88) and accurately and reliably positions exposed IV tubing (22) in contact with the peristaltic fingers of peristaltic infusion pump (84). IV tube set (22) attaches to a fluid vial (90), and a portion of the length of IV tube set (22) is contained within drug cassette (86). Another portion of IV tube set (22) lies external to drug cassette (86) to facilitate the interaction with peristaltic pump (84). IV tubing (22) is coiled within drug cassette (86) and has a length to reach a patient removed from PRU (70). A fluid detection sensor (not shown) may be mounted to an inner wall of drug cassette (86). Such a fluid detection sensor may comprise any one of known fluid sensors, such as the MTI-2000 Fotonic Sensor, or the Microtrak-II CCD Laser Triangulation Sensor both by MTI Instruments Inc. IV tube set (22) may run through the fluid detection sensor before exiting drug cassette (86). PRU (70) may include features operable to prime IV tubing (22) with relative ease for a user. Various examples of how such priming may be provided are disclosed in U.S. Pat. No. 7,833,213, the disclosure of which is incorporated by reference herein.

In the present example, drug cassette (86) includes just one vial (90). However, it should be understood that some versions of drug cassette (86) may include several vials (90). Such vials (90) may include the same drug. Alternatively, a plurality of vials (90) associated with a single drug cassette (86) may include a variety of different kinds of drugs. In other words, a single drug cassette (86) may be used to selectively deliver two or more drugs simultaneously and/or in a particular sequence. While vials (90) are used in the present example, it should be understood that any other suitable type of container may be used as will be understood by those of ordinary skill in the art in view of the teachings herein. It should also be understood that some versions of PRU (70) may be configured to receive two or more drug cassettes (86). Each such drug cassette (86) may be associated with a single drug (e.g., different drug cassettes (86) used for different drugs), or each drug cassette (86) may be associated with a combination of drugs (e.g., different drug cassettes (86) used for different combinations of drugs).

FIG. 4 shows how components of system (10) interface with each other and with a patient. While not shown in FIG. 3, FIG. 4 shows how PRU (70) includes an integral ECG module (92) and integral cannula module (94). ECG module (92) is coupled with ECG (48) via ECG leads (68) extending from pass-through connection (24). Cannula module (94) is coupled with oral/nasal cannula (46), also through pass-through connection (24). Like modules (54, 58, 64, 66) described above, modules (92, 94) may be easily replaceable with other monitoring modules in the event of malfunction or technological advancement. Modules (92, 94) may also include all of the necessary hardware to operate their respective peripherals, and may be further coupled with a microprocessor-based electronic controller or computer located within PRU (70) and/or BMU (40).

As also shown in FIG. 4, PRU (70) of the present example is coupled with an external oxygen source (100), an external power source (102), and an external monitor (104). External oxygen source (100) may by regulated by one or more components of PRU (70), which may deliver oxygen from oxygen source (100) to the patient based on one or more parameters sensed by BMU (40), based on drug delivery from cassette (86), and/or based on other factors. External power source (102) may be used as a primary source of power for PRU (70), with a battery (96) being used as a backup power source. Alternatively, battery (96) may be used as a primary source of power for PRU, with external power source (102) being used for backup power and/or to charge battery (96). External monitor (104) may be used to supplement or to substitute the display features of touch screen assembly (42) and/or touch screen assembly (72). For instance, external monitor (104) may display information including patient physiological parameters, status of operation of system (10), warning alerts, etc. PRU (70) and/or BMU (40) may communicate with external monitor (104) via cable, wirelessly (e.g., via RF transmission, etc.), or otherwise. Other examples of components, features, and functionality that may be incorporated into PRU (70) will be described in greater detail below; while still further examples of components, features, and functionality that may be incorporated into PRU (70) will be apparent to those of ordinary skill in the art in view of the teachings herein.

### II. Drug Delivery Methods

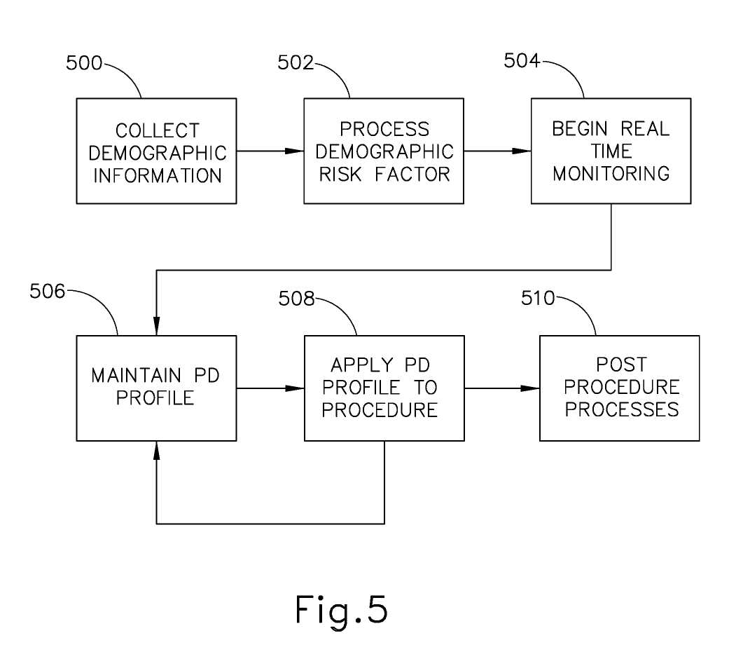

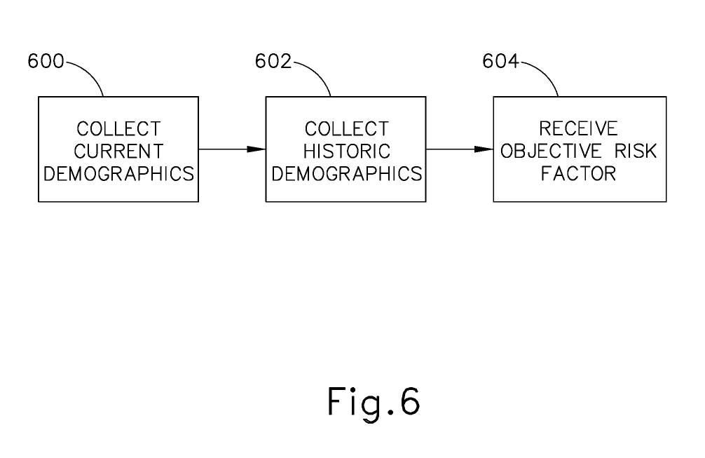

FIG. 5 shows an exemplary method of managing drug delivery based upon patient data. The steps of FIG. 5, as well as the steps and software objects shown in FIG. 6-10, may be performed or maintained by a processing device that is configured to execute a set of appropriate instructions. The device performing these steps may be, for example, one or more of a BMU (40), PRU (70), a standalone device, such as a laptop computer, mobile device, or proprietary medical device, or another similar device that may be configured to receive information from one or more medical monitors and medical record servers, process received information, and transmit a response to one or more devices. For ease of discussion, the following discussions and examples will refer to PRU (70) as the device that is performing and maintaining the steps and structures shown in FIG. 5-10, though it should be understood that this is just one merely illustrative example of hardware that may be used to perform and maintain these steps and structures.

In order to ready PRU (70) for use in a procedure where a pharmacodynamic (PD) profile will be used to manage factors such as drug delivery, equipment configurations, and alarm thresholds, demographic information may be collected (block 500) to provide information that may be used to process and create (block 502) an initial risk based profile based upon one or more of patient history, physiology, or demographics. Real time monitoring of a patient's current physiological state (block 504) may then begin. While a patient is monitored in real time (block 504), information gathered from various monitors may be received by PRU (70) and used to create and maintain a PD profile (block 506) throughout a medical procedure (e.g., surgery). As the PD profile changes in response to monitored characteristics of the patient, the new PD profile may be applied (block 508) to the medical procedure in order to update the configuration of one or more devices being used in the medical procedure.

Maintaining (block 506) and applying (block 508) the PD profile may continue through the completion of a procedure, and may also continue after a medical procedure during a patient recovery time or until PRU (70) and its associated devices and monitors are removed from the patient. Examples of the manner in which a PD profile may be used include establishing or modifying safeguards in the control algorithm of system (10). For example, if a patient has a low ejection fraction, system (10) may increase the timeouts between doses, accounting for the increased circulation time. Another example is a dynamic scaling of calculated doses to a lean body moss indicator, recognizing that a sole weight based calculation for dosing may result in an increased plasma concentration for patients with a very high body mass index. Another example might be dose changes based on age, where dose values may be decreased for geriatric patients.

Once the medical procedure is complete and data is no longer being monitored in real time, one or more post procedure processes may occur (block 510) such as storing characteristics of the patient real time data for future use, storing the patients complete PD profile for future use, storing information relating to a clinician's interactions with PRU (70), including manual reconfigurations of the PD profile or manual refusal of automated PD profile changes. This may be useful in future medical procedures with a patient, where PRU (70) may be able to use the complete PD profile or portions of the real time data to more accurately determine an initial profile before real time monitoring begins. Additionally, PRU (70) may be able to use this data to determine that a particular clinician tends to be more conservative with PD profile configuration and application (block 508), and PRU (70) may create more conservative PD profiles or cease automatic profile application (block 508) entirely in response.

FIG. 6 depicts a flowchart of exemplary steps that may be performed to collect demographic information (block 500). The system may collect current demographics (block 600) in various ways. Demographics may include a patient's height, weight, lean body mass, body mass index, ASA classification, ejection fraction, prior medications, or similar characteristics. Such demographic data may be received by the system as part of a manual process, or as part of an automated process. For example, a clinician may manually enter, via an interface of PRU (70) or a device in communication with PRU (70), observed or manually measured characteristics such as height or weight; or may manually enter an observation based characteristic such as ASA classification. Additionally or alternatively, one or more characteristics may be automatically determined and received by PRU (70), such as where a scale integrated into a medical examination table may determine the patient's weight and provide it to PRU (70) without manual intervention. Historic demographics may also be collected (block 602) from an electronic medical record database or other device storing historic demographic information for a patient. This information may include patient demographic information over a period of time, such as the patient's weight gain or loss during the prior year, a history of the patient's medications, a history of the patient's allergies or other medical conditions, and similar characteristics that may be available from an external server or external storage device. Current demographic information and historic demographic information may be used separately or in combination, even where the data is in conflict, such as where a patient's current weight is different than the patient's historic weight, as a trend of recent weight loss or weight gain may influence a PD profile in addition to the patient's current weight.

PRU (70) may also receive an objective risk factor (block 604). The objective risk factor is a characteristic determined by one or more members of an anesthesia care team, and may provide an indicator of the team's opinion of the patient's risk factor based upon initial observations. This risk factor could be represented as a number on a scale of risk factors, such as a number between 1 and 10 or 1 and 100, or as a general indicator such as high, medium or low. This risk factor could be based upon the opinions and experience of the members of the team, and in some situations may mirror the manual, automatic, or historic patient demographics, but in other situations may include additional unmeasured demographics such as a team member's observations of a particular patient's pallor, expressed nervousness relating to an upcoming procedure, expressed concerns based upon past sedation procedures, or other observable or expressed information relating to the patient that might influence the patient's reactions to sedation. After collecting or receiving one or more of the current demographics, historic demographics, and risk factor indicators, PRU (70) may process the demographics and objective risk factor to determine an initial profile.

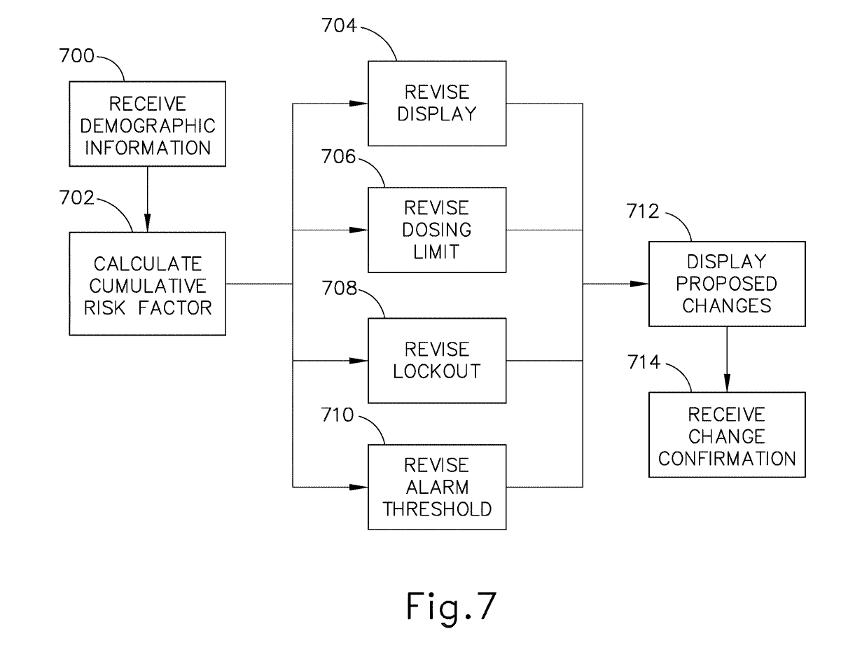

FIG. 7 depicts a flowchart of exemplary steps that may be performed to process risk factors. Once demographic information and risk factor information has been received (block 700) by PRU (70), a cumulative risk factor may be calculated (block 702). The cumulative risk factor may be a numeric or general indicator of the totality of risk factors inherent in the patient's demographics and objective risk factor. The cumulative risk factor may be determined by assigning a weighted value to each patient demographic and objective risk factor and totaling the weighted values to determine a cumulative value. For example, in one example a cumulative risk factor may be determined on a scale between 1 and 100. A patient BMI may have a series of weighted risk values corresponding to each BMI value, such that a healthy BMI may have a risk value of 0, while patients who are underweight or overweight have a risk value of 5, and patients who are obese have a risk value of 10. ASA classification may have different values for each classification in increments of 5, such as ASA I having a risk value of 5, and ASA V having a risk value of 25. Objective risk factor may have an indicator of low, medium, or high, with risk values of 0, 25, and 50, respectively. In this example, a patient of healthy weight, with no major pre-existing conditions, who is observably classified as a low sedation risk may have a cumulative risk factor of 0; while a patient who is obese, has serious health issues caused by diabetes, and is observably classified as a high sedation risk may have a cumulative risk factor of 75. The determined cumulative risk factor may be associated with an initial profile appropriate for that cumulative risk factor, so that once a cumulative risk factor is determined (block 702), PRU (70) may automatically revise a set of display configurations (block 704), a set of dosing limits (block 706), a set of drug delivery lockout settings (block 708), and a set of alarm thresholds (block 710).

The set of display configurations may include settings for visual displays of PRU (70), BMU (40), or other devices having displays, and may include settings controlling the type of information that is shown on each display. For example, a particular cumulative risk factor and initial profile may indicate that the most important information for the upcoming procedure is a patient's heart rate, and the system may therefore configure one or more displays to prominently display heart rate; while a different initial profile may instead indicate that a patient's blood pressure is most important, resulting in a display configuration that instead prominently features blood pressure readings. In a similar manner, any information measured by sensors may be displayed as would be advantageous for a particular cumulative risk factor and initial profile.

The set of dosing limits may include minimum and maximum delivery values for one or more drugs that may be automatically delivered through a drug delivery device (e.g., PRU (70)) or manually delivered by a clinician. An initial profile that indicates a low risk factor may allow for more liberal dosing limits to better manage patient discomfort, while an initial profile that indicates a high risk factor may enforce more conservative dosing limits that may sacrifice some level of patient comfort in exchange for patient safety. The particular dosing limits will vary widely based upon the drug being delivered, the procedure being performed, the risk factor and initial profile, and recent medical research, as well as subjective factors such as the desires of a particular institution where the technology is being used or the particular members of an anesthesia team using the technology, with such variations being apparent to one of ordinary skill in the art in light of the disclosure herein. Similarly, the set of drug delivery lockouts may include lockout limits to prevent manual intervention that would cause drug delivery to exceed or fall short of safe amounts, and will vary widely based upon the above factors.

The set of alarm thresholds may include a plurality of alarms relating to drug delivery or patient physiology, and may include triggers that will cause audible and/or visual alarms to occur when delivery of a particular drug falls outside a desired range, when patient heart rate or blood pressure falls outside of a desired range, when a procedure time exceeds a desirable period of time, or similar situations where it may be desirable to alert the anesthesia team to a particular occurrence or circumstance. As with dosing limits and delivery lockouts, the particular alarm thresholds may vary greatly based upon the drugs being delivered, the procedure being performed, the risk factor and initial profile, and recent medical research, as well as subjective factors such as the desires of a particular institution where the technology is being used or the particular members of an anesthesia team using the technology, with such variations being apparent to one of ordinary skill in the art in light of the disclosure herein.

After one or more revisions have been prepared based upon an initial profile and cumulative risk factor, some versions of this technology may cause PRU (70) or another display to show the changes that the system is preparing to make (block 712) based upon the determination of the initial profile. The proposed changes may be displayed (block 712) in such a way that one or more members of the anesthesia team may review them and then make manual adjustments, confirm, or refuse one or more the proposed changes (block 714) via an interface of PRU (70). In this manner, if PRU (70) displays an indication that the system is preparing to change the delivery rate of three different drugs based upon an initial profile and cumulative risk factor, a member of the anesthesia team may adjust the proposed delivery rate for a first drug, cancel the proposed delivery change for a second drug, and confirm the proposed delivery change for a third drug (block 714). Alternately, the clinician could, via a single button press within an interface, confirm or refuse all proposed changes (block 714).

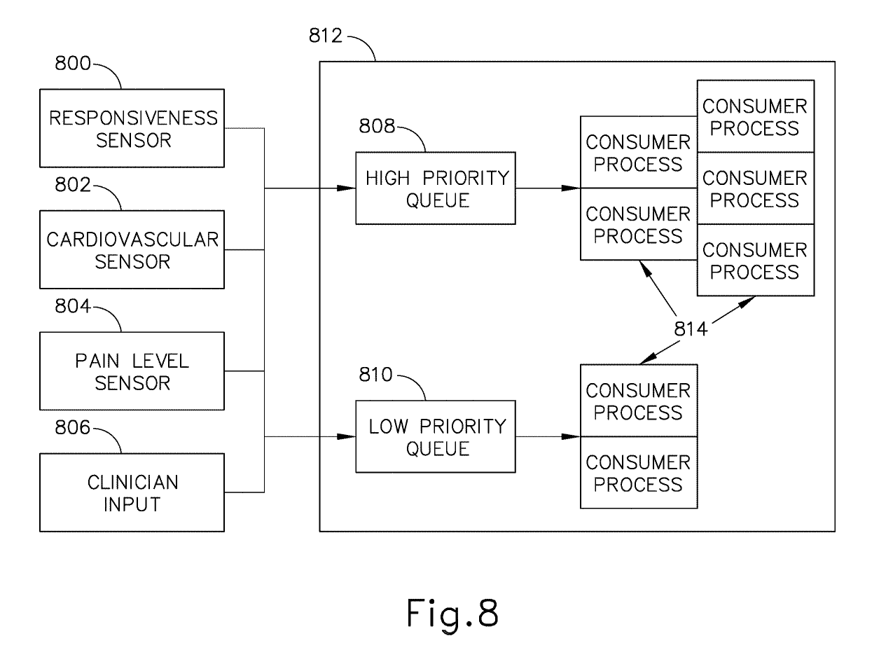

FIG. 8 depicts a schematic view of an exemplary queue for receiving and organizing real time data (block 504) as it is received during a procedure. Real time data could include data generated from an ARM, bi-spectral index monitor (BIS), hemodynamic monitor, cardio-respiratory monitor, and a manual clinician input indicating a patient's level of pain, comfort, or other observable characteristics. Real time data will be used to create and maintain a PD profile throughout a medical procedure based upon the real time and additional drug delivery related data such as drug infusion rate, plasma concentration, and effect site concentration. By using both real time data from monitors and drug delivery related data that may be available from monitors (e.g., BMU (40)) and/or a drug delivery device (e.g., PRU (70)), the PD profile may be created and maintained based upon, for example, a dose response curve, a table of values and responses, or other mathematical construct that shows the relationship between drug delivery and measurable effect on the patient.

As an example, FIG. 8 shows a responsiveness sensor (800), cardiovascular sensor (802), pain level sensor (804), and clinician input device (806) that each generate data in real time during a medical procedure (e.g., while the patient is under sedation during surgery), with the data being received by a profile device (812), which, as described above, may be a PRU (70), BMU (40), or similar device. The profile device may be configured to have a high priority queue (808) and a low priority queue (810), with real time data being placed in one of the queues (808, 810) after it is received. Queuing of data might be by origin, by real time data type, or by a real time data classification. For example, in some versions that queue data by origin, all real time data coming from the cardiovascular sensor (802) may be considered high priority data and be inserted into the high priority queue (808), while all data coming from the pain level sensor (804) may be considered low priority data and be inserted into the low priority queue (810).

In other versions that queue data by type, all data relating to a patient's heart rate may be placed into a high priority queue (808), regardless of its origin, so that if two different sensors provide overlapping data sets relating to heart rate, the portions of the data sets relating to heart rate may be placed into a high priority queue (808) while portions of the data sets not relating to heart rate may be placed into a low priority queue (810).

In other versions that queue data by classification, certain events within data may be classified as high priority while other events from the same data set may be considered low priority. For example, with a sensor providing patient heart rate data, data indicating a heart rate within normal boundaries may be placed into a low priority queue (810) while data indicating a heart rate below normal boundaries may be placed into a high priority queue (808).

As queues (808, 810) are populated with data, one or more consumer processes (814) may be configured to select portions of data from one or more of the queues (808, 810) so that the consumer process (814) may process the data. Consumer processes may be configured to consume from queues (808, 810) in a variety of ways. For example, in the example of FIG. 8, five consumer processes (814) are configured to exclusively select from the high priority queue (808); while two consumer processes (814) are configured to exclusively select from the low priority queue (810). However, in other versions, there may be a pool of ten consumer processes (814) that are configured to consume from the high priority queue (808) first, so long as it contains data; and consume from the low priority queue (810) only when the high priority queue (808) is empty. In yet other examples, a single consumer process (814) may consume from a high priority queue (808) so long as it is empty, then consume from a low priority queue (810) thereafter; or may consume equally between the two; or may consume from a high priority queue (808) based upon a ratio. The above described queue configurations as well as the queue configurations shown in FIG. 8 are exemplary only, and many variations will be advantageous in different situations, including variations on the number of queues (808, 810), the number of consumer processes (814), and the manner in which consumer processes (814) select from a queue (808, 810), with such variations being apparent to one of ordinary skill in the art in light of this disclosure.

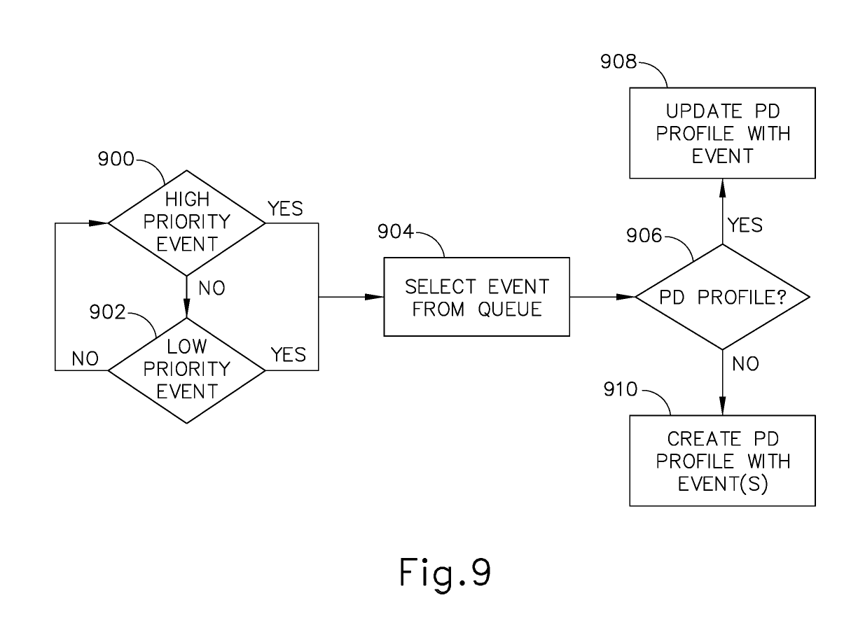

FIG. 9 shows a flowchart of exemplary steps that may be performed to create and maintain a pharmacodynamic profile (block 506). The steps of FIG. 9 may be performed by one or more consumer processes configured to first select from a high priority event queue (808) and, when it is empty, select from a low priority queue (810). When used in the following discussion, it should be appreciated that a queue (808, 810) may store complete sets or subsets of real time data, either in a raw or formatted form; and such data, whether a subset or complete set, may be referred to as an event because it represents one or more patient physiological events that have occurred and have been captured by the sensors. When a consumer process becomes available, it will determine (block 900) if there is real time data representing one or more events in the high priority queue (808). If there is an event in the high priority queue (808), the event will be selected (block 904) from the queue (808) by the consumer process (814). If there is no event in the high priority queue (808), the consumer process (814) will determine (block 902) if there are any events in the low priority queue (810). If there is an event in the low priority queue (810), the event will be selected (block 904) from the queue (810) by the consumer process (814). If there is no event in the low priority queue (810), the consumer process (814) may alternate between checking (block 900, block 902) one or more high priority and low priority queues (808, 810) until events become available.

In different versions, the consumer process (814) may select (block 904) from one or more queues (808, 810) based upon a ratio (i.e. select from high priority queue (808) four times for each one time it selects from a low priority queue (810)), or may be dedicated to a single queue (i.e. only select from high priority queues (808), or only select from low priority queues (810)), or other similar configurations that may be desirable based upon such factors as processing capability, multithread processing capability, the numbers and types of sensors providing real time data, cost and desired complexity of the profile device (812).

As events are selected (block 904) by the consumer process (814), the consumer process (814) will determine if the profile device (812) is currently maintaining a PD profile (block 906). Generally, during operation, the profile device (812) will always be maintaining an active PD profile, even if it is only based upon a small set of real time data. However, where, for example, the profile device (812) has only recently started to process real time data, or the profile device (812) has been manually reset or restarted, there may not be an existing PD profile (block 906). In such instances, the consumer process (814) may itself create, or cause another process of the profile device (812) to create, a new PD profile based upon the currently processed real time data (block 910). If there is an existing PD profile (block 906), the currently existing PD profile may be updated (block 908) based upon the new real time data.

PD profiles may track a patient's risk level throughout the procedure along a numerical scale, or may identify particular combinations of demographic factors as relating to particular PD profiles. For example, as real time data is processed and tracked within a PD profile, the real time data may indicate that a patient's cardiac and respiratory activity is steadily dropping to potentially dangerous levels. As this real time data is received and processed over time, the PD profile may steadily move along a numerical risk scale of, for example, 1 to 10 or 1 to 100, with each different point or each of several points resulting in a different set of changes to drug delivery and alarm configurations. Alternately, certain combinations of real time data may trigger certain PD profile based configurations, either in the alternative to or in combination with a numerical scale. For example, if real time data is received and processed indicating a specific range of heart rate, blood pressure, and breathing rate that have historically been identified as a dangerous physiological response to sedation, the PD profile may, rather than moving along a scale, trigger a set of changes to drug delivery and alarm thresholds that have been configured to address the specific real time data being received.

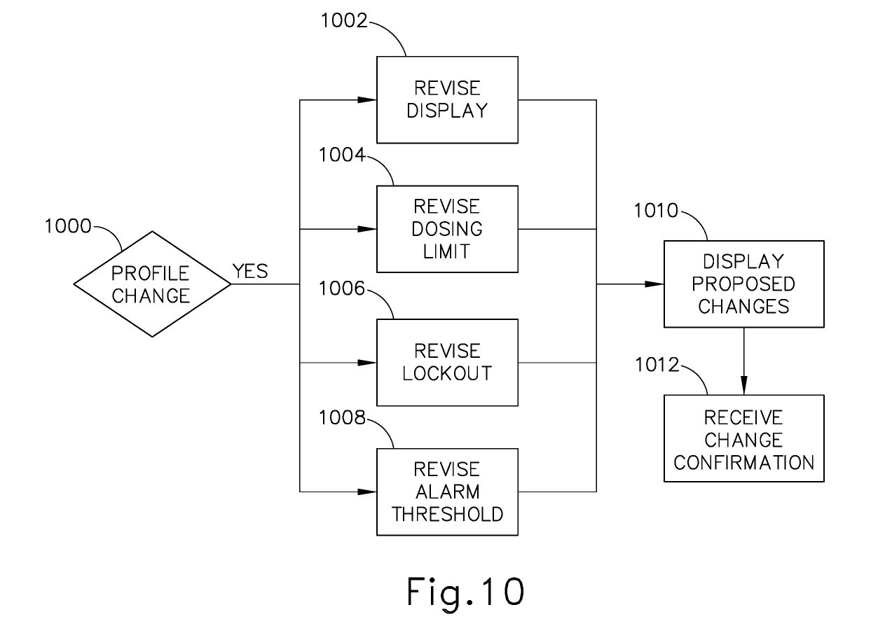

FIG. 10 shows a flowchart of exemplary steps performed to apply a pharmacodynamic profile to an ongoing procedure (block 508). As PD profiles are created (block 910) or modified (block 908), the new or modified PD profile may trigger a corresponding profile based change in one or more profile configuration (block 1000). This may occur as described above, such as when a PD profile moves along a numerical scale in response to real time data, based upon particular combinations of real time data, or similar triggers. When a profile based change is triggered (block 1000) by a PD profile, one or more actions may result such as a revision to the configuration of device displays (block 1002), revision of dosing limits for one or more drugs (block 1004), revision of drug delivery lockout for one or more drugs (block 1006), or revision of one or more alarm thresholds relating to drug delivery, patient physiology, or other characteristics of the procedure (block 1008). As change revisions are prepared, the profile device (812) may display the proposed changes (block 1010) so that a clinician may review, change, refuse, and confirm the changes (block 1012). As with the initial profile, these changes may be confirmed in whole, refused in whole, or partially confirmed, refused, modified, or the like via an interface of the profile device (812).

### III. Exemplary Combinations

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A method comprising: (a) receiving a set of demographic information for a patient; (b) determining one or more cumulative risk factors based upon the set of demographic information; (c) configuring a set of medical devices with an initial profile based upon the one or more cumulative risk factors; (d) receiving a set of physiological information from a set of patient monitors, the set of physiological information describing one or more characteristics of a patient during a medical procedure; (e) maintaining, in real time, a pharmacodynamic profile based upon the set of physiological information; and (f) configuring the set of medical devices with a configuration profile based upon the pharmacodynamic profile.

### Example 2

The method of Example 1, wherein the set of demographic information comprises at least three of the following: (i) a patient height, (ii) a patient age, (iii) a patient's lean body mass, (iv) a patient body mass index, (v) a patient health classification, (vi) a patient ejection fraction, (vii) a prior medication history, (viii) an assessment of a patient's airway, (ix) a patient's gender, (x) a patient's ASA risk classification (I, II, III, IV, V), or (xi) an objective anesthesia risk factor.

### Example 3

The method of Example 2, wherein the objective anesthesia risk factor comprises an indication that a clinician considers the patient to be at high risk for sedation related complications or an indication that the clinician considers the patient to be at low risk for sedation related complications.

### Example 4

The method of Example 3, wherein the one or more cumulative risk factors is a numeric representation of the cumulative risk of sedation related complications as indicated by the set of demographic information.

### Example 5

The method of any one or more of Examples 1 through 4, wherein the initial profile comprises: (i) a drug delivery limitation setting, (ii) a drug delivery lockout setting, (iii) an alarm threshold setting, and (iv) a user display setting.

### Example 6

The method of any one or more of Examples 1 through 5, wherein the set of medical devices comprises a drug delivery device and a procedure room unit.

### Example 7

The method of any one or more of Examples 1 through 6, wherein the set of physiological information comprises: (i) a patient responsiveness indicator, (ii) a cardiorespiratory indicator, (iii) a patient pain indicator, and (iv) a clinician entered patient comfort indicator.

### Example 8

The method of Example 7, wherein the set of physiological information further comprises: (i) a drug infusion rate, (ii) a plasma concentration, and (iii) an effect site concentration.

### Example 9

The method of any one or more of Examples 1 through 8, wherein the pharmacodynamic profile is selected from the group consisting of a dose response curve and a table of drug delivery values and physiological responses.

### Example 10

The method of any one or more of Examples 1 through 9, wherein the configuration profile comprises: (i) a drug delivery limitation setting, (ii) a drug delivery lockout setting, (iii) an alarm threshold setting, and (iv) a user display setting.

### Example 11

The method of any one or more of Examples 1 through 10, further comprising the steps of: (a) displaying to a clinician the configuration profile before the set of medical devices are configured with the configuration profile; (b) receiving an indicator from the clinician that the configuration profile is acceptable; and (c) in response to receiving the indicator from the clinician, configuring the set of medical devices with the configuration profile.

### Example 12

The method of any one or more of Examples 1 through 11, wherein the configuration profile comprises a first medical device configuration and a second medical device configuration, the method further comprising the steps of: (a) displaying to a clinician the configuration profile before the set of medical devices are configured with the configuration profile; (b) receiving an indicator from the clinician that the first medical device configuration is acceptable; (c) receiving an indicator from the clinician that the second medical device configuration is not acceptable; and (d) configuring the set of medical devices with the first medical device configuration and discarding the second medical device configuration.

### Example 13

The method of any one or more of Examples 1 through 12, wherein the configuration profile is configured to cause the set of medical devices to provide a conservative sedation plan when the one or more cumulative risk factors indicates the patient is at a high risk of sedation related complications; wherein the configuration profile is configured to the cause the set of medical to provide a liberal sedation plan when the one or more cumulative risk factors indicates the patient is at a low risk of sedation related complications.

### Example 14

The method of Example 13, wherein the initial profile is configured to cause the set of medical devices to provide a conservative sedation plan when the one or more cumulative risk factors indicates the patient is at a high risk of sedation related complications; wherein the initial profile is configured to the cause the set of medical to provide a liberal sedation plan when the one or more cumulative risk factors indicates the patient is at a low risk of sedation related complications.

### Example 15

A method comprising: (a) receiving, at a profile device, a set of demographic information for a patient, from a medical record server; (b) determining one or more cumulative risk factors based upon the set of demographic information; (c) configuring a set of medical devices with an initial profile based upon the one or more cumulative risk factors; (d) receiving, at the profile device, a set of physiological information from a set of patient monitors, the set of physiological information being indicative of one or more biological characteristics of a patient during a medical procedure; (e) maintaining, in real time, a pharmacodynamic profile based upon the set of physiological information; and (f) configuring the set of medical devices with a configuration profile based upon the pharmacodynamic profile.

### Example 16

The method of Example 15, wherein the profile device comprises one or more of a procedure room unit or a bedside monitor unit.

### Example 17

The method of any one or more of Examples 15 through 16, wherein the set of medical devices comprises one or more of a drug delivery device, a procedure room unit, or a bedside monitor unit.

### Example 18

The method of any one or more of Examples 15 through 17, wherein the set of patient monitors comprises one or more of an automated responsiveness monitor, a bi-spectral index monitor, a blood pressure monitor, a skin galvanic sensor, or a clinician interface for indicating patient comfort level.

### Example 19

An apparatus for managing pharmacodynamic (PD) profiles, the apparatus comprising: (a) a profile device; (b) a medical record server in communication with the profile device; (c) a set of medical devices in communication with the profile device; and (d) a set of medical monitors configured to provide a set of real time data to the profile device, the set of real time data comprising a set of physiological information; wherein the profile device is configured to: (i) receive a set of demographic information from the medical record server, (ii) determine one or more cumulative risk factors based upon the set of demographic information, (iii) configure the set of medical devices with an initial profile based upon the one or more cumulative risk factors, (iv) receive the set of real time data from the set of patient monitors, (v) maintain, in real time, a PD profile based upon the set of physiological information, and (vi) configure the set of medical device with a configuration profile based upon the PD profile.

### Example 20

The apparatus of Example 19, wherein the initial profile is configured to cause the set of medical devices to provide a conservative sedation plan when the one or more cumulative risk factors indicates the patient is at a high risk of sedation related complications; wherein the initial profile is configured to the cause the set of medical to provide a liberal sedation plan when the one or more cumulative risk factors indicates the patient is at a low risk of sedation related complications.

### IV. Miscellaneous

It should be understood that any of the examples described herein may include various other features in addition to or in lieu of those described above. By way of example only, any of the devices herein may also include one or more of the various features disclosed in any of the various references that are incorporated by reference herein. It should also be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

It should further be understood that while various figures show certain steps occurring both in series and in parallel, this is not a requirement and any of the steps shown may occur either in series or in parallel, unless it is explicitly or implicitly stated otherwise. Further, it should be understood that when discussing that data is sent, received, transmitted, or similar terms, the sender of data may be memory or processor of a device, or a process executed by a device, and the receiver may be a different memory or processor of the same device, or a different process executed by the same device, such that a device may send and receive data within different components or processes of itself in order to organize or efficiently process data.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

I/We claim:

1. A method comprising:
(a) receiving a set of demographic information for a patient;
(b) determining one or more cumulative risk factors based upon the set of demographic information;
(c) configuring a set of medical devices with an initial profile based upon the one or more cumulative risk factors;
(d) receiving a set of physiological information from a set of patient monitors, the set of physiological information describing one or more characteristics of a patient during a medical procedure;
(e) maintaining, in real time, a pharmacodynamic profile based upon the set of physiological information; and
(f) configuring the set of medical devices with a configuration profile based upon the pharmacodynamic profile.

2. The method of claim 1, wherein the set of demographic information comprises at least three of the following:
(i) a patient height,
(ii) a patient age,
(iii) a patient's lean body mass,
(iv) a patient body mass index,
(v) a patient health classification,
(vi) a patient ejection fraction,
(vii) a prior medication history,
(viii) an assessment of a patient's airway,
(ix) a patient's gender,
(x) a patient's ASA risk classification (I,II,III,IV,V)
(xi) an objective anesthesia risk factor.

3. The method of claim 2, wherein the objective anesthesia risk factor comprises an indication that a clinician considers the patient to be at high risk for sedation related complications or an indication that the clinician considers the patient to be at low risk for sedation related complications.

4. The method of claim 3, wherein the one or more cumulative risk factors is a numeric representation of the cumulative risk of sedation related complications as indicated by the set of demographic information.

5. The method of claim 1, wherein the initial profile comprises:
(i) a drug delivery limitation setting,
(ii) a drug delivery lockout setting,
(iii) an alarm threshold setting, and
(iv) a user display setting.

6. The method of claim 1, wherein the set of medical devices comprises a drug delivery device and a procedure room unit.

7. The method of claim 1, wherein the set of physiological information comprises:
(i) a patient responsiveness indicator,
(ii) a cardiorespiratory indicator,
(iii) a patient pain indicator, and
(iv) a clinician entered patient comfort indicator.

8. The method of claim 7, wherein the set of physiological information further comprises:
(i) a drug infusion rate,
(ii) a plasma concentration, and
(iii) an effect site concentration.

9. The method of claim 1, wherein the pharmacodynamic profile is selected from the group consisting of a dose response curve and a table of drug delivery values and physiological responses.

10. The method of claim 1, wherein the configuration profile comprises:
(i) a drug delivery limitation setting,
(ii) a drug delivery lockout setting,
(iii) an alarm threshold setting, and
(iv) a user display setting.

11. The method of claim 1, further comprising the steps of:
(a) displaying to a clinician the configuration profile before the set of medical devices are configured with the configuration profile;
(b) receiving an indicator from the clinician that the configuration profile is acceptable; and
(c) in response to receiving the indicator from the clinician, configuring the set of medical devices with the configuration profile.

12. The method of claim 1, wherein the configuration profile comprises a first medical device configuration and a second medical device configuration, the method further comprising the steps of:
(a) displaying to a clinician the configuration profile before the set of medical devices are configured with the configuration profile;
(b) receiving an indicator from the clinician that the first medical device configuration is acceptable;
(c) receiving an indicator from the clinician that the second medical device configuration is not acceptable; and
(d) configuring the set of medical devices with the first medical device configuration and discarding the second medical device configuration.

13. The method of claim 1, wherein the configuration profile is configured to cause the set of medical devices to provide a conservative sedation plan when the one or more cumulative risk factors indicates the patient is at a high risk of sedation related complications;
wherein the configuration profile is configured to the cause the set of medical to provide a liberal sedation plan when the one or more cumulative risk factors indicates the patient is at a low risk of sedation related complications.

14. The method of claim 13, wherein the initial profile is configured to cause the set of medical devices to provide a conservative sedation plan when the one or more cumulative risk factors indicates the patient is at a high risk of sedation related complications;
wherein the initial profile is configured to the cause the set of medical to provide a liberal sedation plan when the one or more cumulative risk factors indicates the patient is at a low risk of sedation related complications.

15. A method comprising:
(a) receiving, at a profile device, a set of demographic information for a patient, from a medical record server;
(b) determining one or more cumulative risk factors based upon the set of demographic information;
(c) configuring a set of medical devices with an initial profile based upon the one or more cumulative risk factors;
(d) receiving, at the profile device, a set of physiological information from a set of patient monitors, the set of physiological information being indicative of one or more biological characteristics of a patient during a medical procedure;
(e) maintaining, in real time, a pharmacodynamic profile based upon the set of physiological information; and
(f) configuring the set of medical devices with a configuration profile based upon the pharmacodynamic profile.

16. The method of claim 15, wherein the profile device comprises one or more of a procedure room unit or a bedside monitor unit.

17. The method of claim 15, wherein the set of medical devices comprises one or more of a drug delivery device, a procedure room unit, or a bedside monitor unit.

18. The method of claim 15, wherein the set of patient monitors comprises one or more of an automated responsiveness monitor, a bi-spectral index monitor, a blood pressure monitor, a skin galvanic sensor, or a clinician interface for indicating patient comfort level.

19. An apparatus for managing pharmacodynamic (PD) profiles, the apparatus comprising:
(a) a profile device;
(b) a medical record server in communication with the profile device;
(c) a set of medical devices in communication with the profile device; and
(d) a set of medical monitors configured to provide a set of real time data to the profile device, the set of real time data comprising a set of physiological information;
(i) wherein the profile device is configured to:
(ii) receive a set of demographic information from the medical record server,
(ii) determine one or more cumulative risk factors based upon the set of demographic information,
(iii) configure the set of medical devices with an initial profile based upon the one or more cumulative risk factors,
(iv) receive the set of real time data from the set of patient monitors,
(v) maintain, in real time, a PD profile based upon the set of physiological information, and
(vi) configure the set of medical device with a configuration profile based upon the PD profile.

20. The apparatus of claim 19, wherein the initial profile is configured to cause the set of medical devices to provide a conservative sedation plan when the one or more cumulative risk factors indicates the patient is at a high risk of sedation related complications;
wherein the initial profile is configured to the cause the set of medical to provide a liberal sedation plan when the one or more cumulative risk factors indicates the patient is at a low risk of sedation related complications.
